(19) United States
(12) Patent Application Publication
(10) Pub. No.: US 2006/0040112 A1
(43) Pub. Date: Feb. 23, 2006

(54) Thermal interconnect and interface systems, methods of production and uses thereof

(76) Inventors: Nancy Dean, LIiberty Lake, WA (US); Richard Townsend, Post Falls, ID (US); Paula Knoll, San Diego, CA (US); Colin Edie, Spokane, WA (US); My Nguyen, Poway, CA (US); Dan Curran, Mountain View, CA (US)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/519,337

(22) PCT Filed: Jul. 15, 2003
(86) PCT No.: PCT/US03/22710

§ 371 Date: Dec. 22, 2004

Related U.S. Application Data
(60) Provisional application No. 60/396,294, filed on Jul. 15, 2002.

(51) Int. Cl. B32B 9/04; B32B 15/04

(52) U.S. Cl. 428/447; 428/457; 361/704; 156/307.7

(57) ABSTRACT

Layered thermal components described herein include at least one thermal interface component and at least one heat spreader component coupled to the thermal interface component. A method of forming layered thermal components disclosed herein comprises: a) providing at least one thermal interface component; b) providing at least one heat spreader component; and c) physically coupling the at least one thermal interface component and the at least one heat spreader component. At least one additional layer, including a substrate layer, can be coupled to the layered thermal component. A method for forming the thermal interface components disclosed herein comprises a) providing at least one saturated rubber compound, b) providing at least one amine resin, c) crosslinking the at least one saturated rubber compound and the at least one amine resin to form a crosslinked rubber-resin mixture, d) adding at least one thermally conductive filler to the crosslinked rubber-resin mixture, and e) adding a wetting agent to the crosslinked rubber-resin mixture. This method can also further comprise adding at least one phase change material to the thermal interface component A suitable interface material can also be produced that comprises at least one solder material. Additionally, a suitable interface material can be produced that comprises at least one solder material and at least one resin component.

### FIELD OF THE INVENTION

The field of the invention is thermal interconnect systems, thermal interface systems and interface materials in electronic components, semiconductor components and other related layered components applications.

### BACKGROUND

Electronic components are used in ever increasing numbers of consumer and commercial electronic products. Examples of some of these consumer and commercial products are televisions, personal computers, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging.

Components, therefore, are being broken down and investigated to determine if there are better building materials and methods that will allow them to be scaled down to accommodate the demands for smaller electronic components. In layered components, one goal appears to be decreasing the number of the layers while at the same time increasing the functionality and durability of the remaining layers. This task can be difficult, however, given that several of the layers and components of the layers should generally be present in order to operate the device.

Also, as electronic devices become smaller and operate at higher speeds, energy emitted in the form of heat increases dramatically. A popular practice in the industry is to use thermal grease, or grease-like materials, alone or on a carrier in such devices to transfer the excess heat transferd across physical interfaces. Most common types of thermal interface materials are thermal greases, phase change materials, and elastomer tapes. Thermal greases or phase change materials have lower thermal resistance than elastomer tape because of the ability to be spread in very thin layers and provide intimate contact between adjacent surfaces. Typical thermal impedance values range between 0.2-1.6° C. cm²/W. However, a serious drawback of thermal grease is that thermal performance deteriorates significantly after thermal cycling, such as from −65° C. to 150° C., or after power cycling when used in VLSI chips. It has also been found that the performance of these materials deteriorates when large deviations from surface planarity causes gaps to form between the mating surfaces in the electronic devices or when large gaps between mating surfaces are present for other reasons, such as manufacturing tolerances, etc. When the heat transferability of these materials breaks down, the performance of the electronic device in which they are used is adversely affected.

Thus, there is a continuing need to: a) design and produce thermal interface materials and layered components that meet customer specifications while minimizing the size of the device and number of layers; b) produce more efficient and better designed materials and/or components with respect to the compatibility requirements of the material, component or finished product; c) develop reliable methods of producing desired thermal interface materials and layered components comprising contemplated thermal interface and layered materials; and d) effectively reduce the number of production steps necessary for a package assembly, which in turn results in a lower cost of ownership over other conventional layered materials, components and processes.

### SUMMARY

Layered thermal components described herein comprise at least one thermal interface component and at least one heat spreader component coupled to the thermal interface component. A method of forming contemplated layered thermal components comprises: a) providing at least one thermal interface component; b) providing at least one heat spreader component; and c) physically coupling the at least one thermal interface component and the at least one heat spreader component. At least one additional layer, including a substrate layer, can be coupled to the layered thermal component.

A method for forming the thermal interface components disclosed herein comprises a) providing at least one saturated rubber compound, b) providing at least one amine resin, c) crosslinking the at least one saturated rubber compound and the at least one amine resin to form a crosslinked rubber-resin mixture, d) adding at least one thermally conductive filler to the crosslinked rubber-resin mixture, and e) adding a wetting agent to the crosslinked rubber-resin mixture. This method can also further comprise adding at least one phase change material to the thermal interface component.

A suitable interface material can also be produced that comprises at least one resin component and at least one solder material. Another suitable interface material can be produced that comprises at least one solder material.

Various objects, features, aspects and advantages of the present invention will become more apparent from the following detailed description of preferred embodiments of the invention.

### DETAILED DESCRIPTION

A suite of thermal interface materials is described herein that exhibit low thermal resistance for a wide variety of interface conditions and demands. Thermal interconnect materials and layers may also comprise metals, metal alloys and suitable composite materials that meet the following design goals:
a) Can be laid down in a thin or ultra thin layer or pattern;
b) Can conduct thermal energy better than conventional thermal adhesives;
c) Has a relatively high deposition rate;
d) Can be deposited on a surface or other layer without having, pores develop in the deposited layer; and
e) Can control migration of the underlying layer of material.
   Interface materials may comprise PCM45 (where PCM=“phase change material”), which is a high conductivity phase change material manufactured by Honeywell International Inc., or metal and metal-based base materials, including those manufactured by Honeywell International Inc.

A suitable interface material or component should conform to the mating surfaces (“wets” the surface), possess a low bulk thermal resistance and possess a low contact resistance. Bulk thermal resistance can be expressed as a function of the material's or component's thickness, thermal conductivity and area. Contact resistance is a measure of how well a material or component is able to make contact with a mating surface, layer or substrate. The thermal resistance of an interface material or component can be shown as follows:
Θ interface=t/kA+2Θ_{contact} Equation 1
where Θ is the thermal resistance,
   t is the material thickness,
   k is the thermal conductivity of the material
   A is the area of the interface

The term “t/kA” represents the thermal resistance of the bulk material and “2Θ_{contact}” represents the thermal contact resistance at the two surfaces. A suitable interface material or component should have a low bulk resistance and a low contact resistance, i.e. at the mating surface.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components cause the gap to expand and contract with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material should be able to conform to non-planar surfaces and thereby lower contact resistance.

Optimal interface materials and/or components possess a high thermal conductivity and a high mechanical compliance, e.g. will yield elastically when force is applied. High thermal conductivity reduces the first term of Equation 1 while high mechanical compliance reduces the second term. The layered interface materials and the individual components of the layered interface materials described herein accomplish these goals. When properly produced, the heat spreader component described herein will span the distance between the mating surfaces of the thermal interface material and the heat spreader component thereby allowing a continuous high conductivity path from one surface to the other surface.

Layered thermal components described herein comprise at least one thermal interface component, wherein the thermal interface component may be crosslinkable, and at least one heat spreader component coupled to the at least one thermal interface component. A method of forming contemplated layered thermal components comprises: a) providing a thermal interface component, wherein the thermal interface component may be crosslinkable; b) providing a heat spreader component; and c) physically coupling the thermal interface component and the heat spreader component. At least one additional layer may be coupled with the layered thermal component described herein. The at least one additional layer can comprise another interface material, a surface, a substrate, an adhesive, a compliant fibrous component or any other suitable layer.

Suitable thermal interface components comprise those materials that can conform to the mating surfaces (“wets” the surface), possess a low bulk thermal resistance and possess a low contact resistance. A contemplated thermal interface component is produced by combining at least one rubber compound and at least one thermally conductive filler. Another contemplated thermal interface component is produced by combining at least one rubber compound, at least one crosslinker moiety, crosslinking compound or crosslinking resin and at least one thermally conductive filler. These contemplated interface materials take on the form of a liquid or “soft gel”. As used herein, “soft gel” means a colloid in which the disperse phase has combined with the continuous phase to form a viscous “jelly-like” product. The gel state or soft gel state of the thermal interface component is brought about through a crosslinking reaction between the at least one rubber compound composition and the at least one crosslinker moiety, crosslinking compound or crosslinking resin. The at least one crosslinker moiety, crosslinking compound or crosslinking resin may comprise any suitable crosslinking functionality, such as an amine resin or an amine-based resin. More specifically, the at least one crosslinker moiety, crosslinking compound or crosslinking resin, such as the amine resin, is incorporated into the rubber composition to crosslink the primary hydroxyl groups on the rubber compounds, thus forming the soft gel phase. Therefore, it is contemplated that at least some of the rubber compounds will comprise at least one terminal hydroxyl group. As used herein, the phrase “hydroxyl group” means the univalent group—OH occurring in many inorganic and organic compounds that ionize in solution to yield OH radicals. Also, the “hydroxyl group” is the characteristic group of alcohols. As used herein, the phrase “primary hydroxyl groups” means that the hydroxyl groups are in the terminal position on the molecule or compound. Rubber compounds contemplated herein may also comprise additional secondary, tertiary, or otherwise internal hydroxyl groups that could also undergo a crosslinking reaction with the amine resin. This additional crosslinking may be desirable depending on the final gel state needed for the product or component in which the gel is to be incorporated.

It is contemplated that the rubber compounds could be “self-crosslinkable” in that they could crosslink intermolecularly with other rubber compounds or intramolecularly with themselves, depending on the other components of the composition. It is also contemplated that the rubber compounds could be crosslinked by the amine resin compounds and perform some self-crosslinking activity with themselves or other rubber compounds.

In preferred embodiments, the rubber compositions or compounds utilized can be either saturated or unsaturated. Saturated rubber compounds are preferred in this application because they are less sensitive to thermal oxidation degradation. Examples of saturated rubbers that may be used are ethylene-propylene rubbers (EPR, EPDM), polyethylene/butylene, polyethylene-butylene-styrene, polyethylene-propylene-styrene, hydrogenated polyalkyldiene “mono-ols” (such as hydrogenated polybutadiene mono-ol, hydrogenated polypropadiene mono-ol, hydrogenated polypentadiene mono-ol), hydrogenated polyalkyldiene “diols” (such as hydrogenated polybutadiene diol, hydrogenated polypropadiene diol, hydrogenated polypentadiene diol) and hydrogenated polyisoprene. However, if the compound is unsaturated, it is most preferred that the compound undergo a hydrogenation process to rupture or remove at least some of the double bonds. As used herein, the phrase “hydrogenation process” means that an unsaturated organic compound is reacted with hydrogen by either a direct addition of hydrogen to some or all of the double bonds, resulting in a saturated product (addition hydrogenation), or by rupturing the double bond entirely, whereby the fragments further react with hydrogen (hydrogenolysis). Examples of unsaturated rubbers and rubber compounds are polybutadiene, polyisoprene, polystyrene-butadiene and other unsaturated rubbers, rubber compounds or mixtures/combinations of rubber compounds.

As used herein, the term “compliant” encompasses the property of a material or a component that is yielding and formable, especially at about room temperature, as opposed to solid and unyielding at room temperature. As used herein, the term “crosslinkable” refers to those materials or compounds that are not yet crosslinked.

As used herein, the term “crosslinking” refers to a process in which at least two molecules, or two portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

More than one rubber compound of each type may be combined to produce a thermal interface component; however, in some contemplated thermal interface components, at least one of the rubber compounds or constituents will be a saturated compound. Olefin-containing or unsaturated thermal interface components, with appropriate thermal fillers, exhibit a thermal capability of less than about 0.5 cm²° C./W. Unlike thermal grease, thermal performance of the thermal interface component will not degrade after thernal cycling or flow cycling in IC devices because liquid olefins and liquid olefin mixtures (such as those comprising amine resins) will crosslink to form a soft gel upon heat activation. Moreover, when applied as a thermal interface component, it will not be “squeezed out” as thermal grease does in use and will not display interfacial delamination during thermal cycling.

Crosslinkers or crosslinking compounds, such as amine or amine-based resins, are added or incorporated into the rubber composition or mixture of rubber compounds primarily to facilitate a crosslinking reaction between the crosslinker and the primary or terminal hydroxyl groups on at least one of the rubber compounds. It should be understood that other resin materials or polymer materials may be added along with or to replace the amine-based resins in order to facilitate a crosslinking reaction. The crosslinking reaction between the amine resin and the rubber compounds produces a “soft gel” phase in the mixture, instead of a liquid state. The degree of crosslinking between the amine resin and the rubber composition and/or between the rubber compounds themselves will determine the consistency of the soft gel. For example, if the amine resin and the rubber compounds undergo a minimal amount of crosslinking (about 10% of the sites available for crosslinking are actually used in the crosslinking reaction) then the soft gel will be more “liquid-like”. However, if the amine resin and the rubber compounds undergo a significant amount of crosslinking (about 40-60% of the sites available for crosslinking are actually used in the crosslinking reaction and possibly there is a measurable degree of intermolecular or intramolecular crosslinking between the rubber compounds themselves) then the gel would become thicker and more “solid-like”.

Amine and amino resins are those resins that comprise at least one amiine substituent group on any part of the resin backbone. Amine and amino resins are also synthetic resins derived from the reaction of urea, thiourea, melamine or allied compounds with aldehydes, particularly formaldehyde. Typical and contemplated amine resins are primary amine resins, secondary amine resins, tertiary amine resins, glycidyl amine epoxy resins, alkoxybenzyl amine resins, epoxy amine resins, melamine resins, alkylated melamine resins, and melamine-acrylic resins. Melamine resins are particularly useful and preferred in several contemplated embodiments described herein because a) they are ring-based compounds, whereby the ring contains three carbon and three nitrogen atoms, b) they can combine easily with other compounds and molecules through condensation reactions, c) they can react with other molecules and compounds to facilitate chain growth and crosslinking, d) they are more water resistant and heat resistant than urea resins, e) they can be used as water-soluble syrups or as insoluble powders dispersible in water, and f) they have high melting points (greater than 325° C. and are relatively non-flammable). Allcylated melamine resins, such as butylated melamine resins, propylated melamine resins, pentylated melamine resins hexylated melamine resins and the like, are formed by incorporating alkyl alcohols during the resin formation. These resins are soluble in paint and enamel solvents and in surface coatings.

Thermal filler particles to be dispersed in the thermal interface component or mixture should advantageously have a high thermal conductivity. Suitable filler materials include metals, such as silver, gallium, copper, aluminum, and alloys thereof; and other compounds, such as boron nitride, aluminum nitride, silver coated copper, silver-coated aluminum, conductive polymers and carbon fibers. Thermal filler particles may also comprise solder materials, such as indium, tin, lead, antimony, tellurium, bismuth, or an alloy comprising at least one of the previously mentioned metals. Combinations of boron nitride and silver or boron nitride and silver/copper also provide enhanced thermal conductivity. Boron nitride in amounts of at least 20 wt % and silver in amounts of at least about 60 wt % are particularly useful. Preferably, fillers with a thermal conductivity of greater than about 20 and most preferably at least about 40 W/m° C. can be used. Optimally, it is desired to have a filler of not less than about 80 W/m° C. thermal conductivity.

At this point it should be understood that, unless otherwise indicated, all numbers expressing quantities of ingredients, constituents, reaction conditions and so forth used in the specification and claims are to be understood as being modified in all instances by the term “about”. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3 d, 4 d, 5 d, and 6 d orbitals surrounding the nucleus of the element. As used herein, the phrase “f-block” means those elements that have electrons filling the 4 f and 5 f orbitals surrounding the nucleus of the element, including the lanthanides and the actinides. Preferred metals include indium, silver, copper, aluminum, tin, bismuth, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes.

Of special efficacy is a filler comprising a particular form of carbon fiber referred to as “vapor grown carbon fiber” (VGCF), such as is available from Applied Sciences, Inc., Cedarville, Ohio. VGCF, or “carbon micro fibers”, are highly graphized types by heat treatment (thermal conductivity=about 1900 W/m° C.). Addition of about 0.5 wt. % carbon micro fibers provides significantly increased thermal conductivity. Such fibers are available in varying lengths and diameters; namely, about 1 millimeter (mm) to tens of centimeters (cm) length and from under about 0.1 to over about 100 μm in diameter. One useful form of VGCF has a diameter of not greater than about 1 μm and a length of about 50 to 100 μm, and possess a thermal conductivity of about two or three times greater than with other common carbon fibers having diameters greater than about 5 μm.

It is difficult to incorporate large amounts of VGCF in polymer systems and interface components and systems, such as the hydrogenated rubber and resin combination already discussed. When carbon microfibers, e.g. (about 1 μm, or less) are added to the polymer they do not mix well, primarily because a large amount of fiber must be added to the polymer to obtain any significant beneficial improvement in thermal conductivity. However, we have discovered that relatively large amounts of carbon microfibers can be added to polymer systems that have relatively large amounts of other conventional fillers. A greater amount of carbon microfibers can be added to the polymer when added with other fibers, which can be added alone to the polymer, thus providing a greater benefit with respect to improving thermal conductivity of the thermal interface component. Desirably, the ratio of carbon microfibers to polymer is in the range of about 0.05 to 0.50 by weight.

Once the thermal interface component that comprises at least one rubber compound, at least one crosslinker or crosslinker compound, and at least one thermally conductive filler has been prepared, the composition must be compared to the needs of the electronic component, vendor, or electronic product to determine if an additional phase change material is needed to change some of the physical properties of the composition. Specifically, if the needs of the component or product require that the composition or interface material be in a “soft gel” form or a somewhat liquid form, then an additional phase change material may not need to be added. However, if the component, layered material or product requires that the composition or material be more like a solid, then at least one phase change material should be added.

Phase-change materials that are contemplated herein comprise waxes, polymer waxes or mixtures thereof, such as paraffin wax. Paraffin waxes are a mixture of solid hydrocarbons having the general formula CₙH₂ₙ₊₂ and having melting points in the range of about 20° C. to 100° C. Examples of some contemplated melting points are about 45° C. and 60° C. Thermal interface components that have melting points in this range are PCM45 and PCM60HD—both manufactured by Honeywell International Inc. Polymer waxes are typically polyethylene waxes, polypropylene waxes, and have a range of melting points from about 40° C. to 160° C.

PCM45 comprises a thermal conductivity of about 3.0 W/mK, a thermal resistance of about 0.25° C.cm²/W (0.0038° C.cm²/W), is typically applied at a thickness of about 0.0015 inches (0.04 mm) and comprises a typical softness of about 5 to 30 psi (plastically flow under). Typical characteristics of PCM45 are a) a super high packaging density—over 80%, b) a conductive filler, c) extremely low thermal resistance, and as mentioned earlier d) about a 45° phase change temperature. PCM60HD comprises a thermal conductivity of about 5.0 W/mK, a thermal resistance of about 0.17° C.cm²/W (0.0028° C.cm²/W), is typically applied at a thickness of about 0.0015 inches (0.04 mm) and comprises a typical softness of about 5 to 30 psi (plastically flow under). Typical characteristics of PCM60HD are a) a super high packaging density—over 80%, b) a conductive filler, c) extremely low thermal resistance, and as mentioned earlier d) about a 60° phase change temperature. TM350 (a thermal interface component not comprising a phase change material and manufactured by Honeywell International Inc.) comprises a thermal conductivity of about 3.0 W/mK, a thermal resistance of about 0.25° C.cm²/W (0.0038° C.cm²/W), is typically applied at a thickness of about 0.0015 inches (0.04 mm) and comprises a typical softness of about 5 to 30 psi (plastically flow under). Typical characteristics of TM350 are a) a super high packaging density—over 80%, b) a conductive filler, c) extremely low thermal resistance, d) about a 125° curing temperature, and e) dispensable non-silicone-based thermal gel.

Paraffin-based phase change materials, however, have several drawbacks. On their own, they can be very fragile and difficult to handle. They also tend to squeeze out of a gap from the device in which they are applied during thermal cycling, very much like grease. The rubber-resin modified paraffin polymer wax system described herein avoids these problems and provides significantly improved ease of handling, is capable of being produced in flexible tape or solid layer form, and does not pump out or exude under pressure. Although the rubber-resin-wax mixtures may have the same or nearly the same temperature, their melt viscosity is much higher and they do not migrate easily. Moreover, the rubber-wax-resin mixture can be designed to be self-crosslinking, which ensures elimination of the pump-out problem in certain applications. Examples of contemplated phase change materials are malenized paraffin wax, polyethylene-maleic anhydride wax, and polypropylene-maleic anhydride wax. The rubber-resin-wax mixtures will functionally form at a temperature between about 50 to 150° C. to form a crosslinked rubber-resin network.

It is also advantageous to incorporate additional fillers, substances or particles, such as filler particles, wetting agents or antioxidants into the thermal interface component. Substantially spherical filler particles can be added to the thermal interface component to maximize packing density. Additionally, substantially spherical shapes or the like will provide some control of the thickness during compaction. Typical particle sizes useful for fillers in the rubber material may be in the range of about 1-20 μm, about 21-40 μm, about 41-60 μm, about 61-80 μm, and about 81-100 μm with a maximum of about 100 μm.

Dispersion of filler particles can be facilitated by addition of functional organometallic coupling agents or “wetting” agents, such as organosilane, organotitanate, organozirconium, etc. Organotitanate acts a wetting enhancer to reduce paste viscosity and to increase filler loading. An organotitanate that can be used is isopropyl triisostearyl titanate. The general structure of organotitanate is RO—Ti(OXRY) where RO is a hydrolyzable group, and X and Y are binder functional groups.

Antioxidants may also be added to inhibit oxidation and thermal degradation of the cured rubber gel or solid thermal interface component. Typical useful antioxidants include Irganox 1076, a phenol type or Irganox 565, an amine type, (at about 0.01% to about 1 wt. %), available from Ciba Giegy of Hawthorne, N.Y. Typical cure accelerators include tertiary amines such as didecylanethylamine, (at about 50 ppm-0.5 wt. %).

At least one catalyst may also be added to the thermal interface component in order to promote a crosslinking or chain reaction between the at least one rubber compound, the at least one amine resin, the at least one phase change material, or all three. As used herein, the term “catalyst” means that substance or condition that notably affects the rate of a chemical reaction without itself being consumed or undergoing a chemical change. Catalysts may be inorganic, organic, or a combination of organic groups and metal halides. Although they are not substances, light and heat can also act as catalysts. In contemplated embodiments, the catalyst is an acid. In other contemplated embodiments, the catalyst is an organic acid, such as carboxylic, acetic, formic, benzoic, salicylic, dicarboxylic, oxalic, phthalic, sebacic, adipic, oleic, palmitic, stearic, phenylstearic, amino acids and sulfonic acid.

A method for forming the thermal interface components disclosed herein comprises a) providing at least one saturated rubber compound, b) providing at least one crosslinker or crosslinker compound, such as an amine resin, c) crosslinking the at least one saturated rubber compound and the at least one crosslinker or crosslinker compound to form a crosslinked rubber-resin mixture, d) adding at least one thermally conductive filler to the crosslinked rubber-resin mixture, and e) adding a wetting agent to the crosslinked rubber-resin mixture. This method can also further comprise adding at least one phase change material to the crosslinked rubber-resin mixture. As discussed herein, liquid and solid thermal interface components can be formed using the contemplated method, along with tapes, electronic components, semiconductor components, layered materials and electronic and semiconductor products.

The contemplated thermal interface component can be provided as a dispensable liquid paste to be applied by dispensing methods (such as screen printing or stenciling) and then cured as desired. It can also be provided as a highly compliant, cured, elastomer film or sheet for pre-application on interface surfaces, such as heat sinks. It can further be provided and produced as a soft gel or liquid that can be applied to surfaces by any suitable dispensing method. Even further, the thermal interface component can be provided as a tape that can be applied directly to interface surfaces or electronic components.

To illustrate several embodiments of the thermal interface components, a number of examples were prepared by mixing the components described in below Examples A through F. As indicated in the tables, the properties of the compositions including viscosity, product form, thermal impedance, modulus of elasticity, and thermal conductivity are also reported.

The examples shown include one or more of the optional additions, e.g., antioxidant, wetability enhancer, curing accelerators, viscosity reducing agents and crosslinking aids. The amounts of such additions may vary but, generally, they may be usefully present in the following approximate amounts (in wt. %): filler up to about 95% of total (filler plus rubbers); wetability enhancer about 0.1 to 1% (of total); antioxidant about 0.01 to 1% (of total); curing accelerator about 50 ppm—0.5% (of total); viscosity reducing agents about 0.2-15%; and crosslinking aids about 0.1-2%. It should be noted the addition at least about 0.5% carbon fiber significantly increases thermal conductivity.

| Composition (by wt %) | A | B | C | D | E | F |
|---|---|---|---|---|---|---|
| Hydrogenated polybutylene mono-ol | 7.5 | 6.3 | 10 | 11.33 | 5 | 18 |
| Hydrogenated polybutadiene diol | none | none | 2 | none | none | none |
| Paraffin Wax | 3.1 | 2.2 | none | none | none | none |
| Alkylated melamine resin (butylated) | 1.7 | 0.4 | 1.33 | 2 | 1 | 4 |
| Organotitanate | 1.5 | 1.0 | 6.67 | 6.67 | 4 | 8 |
| Sulfonic Acid Catalyst | 0.1 | none | none | none | none | none |
| Phenolic Antioxidant | 0.1 | 0.1 | none | none | none | none |
| Aluminum powder | 86 | 90 | 80 | 80 | none | none |
| Silver Powder | none | none | none | none | 90 | none |
| Boron Nitride | none | none | none | none | none | 70 |
| Product Form | Tape | Tape | Liquid | Liquid | Liquid | Liquid |
| Thermal Impedance (° C. cm2/w) | 0.25 | 0.18 | 0.25 | 0.25 | 0.3 | 0.35 |
| Thermal conductivity (w.m/° C.) | 3.0 | 5.0 | 2.8 | 2.8 | 2.3 | 2.0 |
| Modulus of Elasticity, Pa | 300000 | 270000 | 500000 | 300000 | 280000 | 270000 |
| Viscosity, Pa.s | N/A | N/A | 200 | 160 | 150 | 220 |

Another suitable interface material can be produced/prepared that comprises at least one solder material. Contemplated solder materials are selected in order to provide the desired melting point and thermal transfer characteristics. Contemplated solders are selected to melt in the temperature range of about 40° C. to about 250° C. In some contemplated embodiments, the solder materials comprise a pure metal, such as indium, tin, lead, silver, copper, antimony, gallium, tellurium, bismuth, or an alloy comprising at least one of the previously mentioned metals. In more contemplated embodiments, pure indium is selected as the solder material, since it has a melting point of about 156° C. In these embodiments, indium can be readily electrodeposited from electrolytes containing indium cyanide, indium fluorobate, indium sulfamate and/or indium sulfate. Once the indium is plated onto the heat spreader, a layer of a material, such as a noble metal and/or a low temperature silicide former—such as silver, platinum or palladium—may cover the indium layer in order to control indium oxidation when exposed to air. Platinum and palladium are good choices for this layer material, because they are low temperature silicide formers. Mixed suicides that have a lower formation temperature may also be used in these embodiments, including palladium silicide. The layer of material is understood to be a “flash layer” on top of the bulk indium plating layer, and at least one of these “flash layers” can be coupled to the plating layer. The layer of material can also be coupled to the silicon when the solder material is reflowed, in order to act as an oxide barrier and to promote bonding at the silicon surface.

As mentioned earlier, other contemplated solder materials comprise alloys that are plated onto the heat spreader. The alloy materials used in these contemplated embodiments may be dilute alloys and/or those alloys that are silicide formers, such as palladium, platinum, copper, cobalt, chromium, iron, magnesium, manganese, nickel and in some embodiments, calcium. Contemplated concentrations of these alloys would be about 100 ppm to about 5% of the alloy.

In other contemplated embodiments, the alloy includes an element, material, compound or composition that improves the wettability of the alloy to the heat spreader. It should be understood that in this application, improving the wettability of the alloy comprises reducing the amount of surface oxides. Suitable elements that improve wettability are gold, calcium, cobalt, chromium, copper, iron, manganese, magnesium, gallium, molybdenum, nickel, phosphorus, palladium, platinum, tin, tantalum, titanium, vanadium, tungsten, zinc, and/or zirconium.

The solder or solder-based thermal material can be deposited in any number of forms and in any suitable manner, including depositing the material as a paste or as a pure metal and deposting the material by plating, by printing the solder in liquid form, or by attaching a preform of the material to an underlying substrate.

Once the thermal interface layer is deposited it is understood that it will have a relatively high thermal conductivity as compared to conventional thermal adhesives and other thermal layers. Additional layers, such as a metallized silicon die can be soldered directly to the thermal interconnect layer without the use of such damaging materials as corrosive fluxes that may be needed to remove oxides of the materials, such as nickel, used to produce the thermal spreader.

Yet another suitable interface material can also be produced/prepared that comprises a resin mixture and at least one solder material. The resin material may comprise any suitable resin material, but it is preferred that the resin material be silicone-based comprising one or more compounds such as vinyl silicone, vinyl Q resin, hydride functional siloxane and platinum-vinylsiloxane. The solder material may comprise any suitable solder material, such as those previously described, or metal, including indium, silver, copper, aluminum, tin, bismuth, gallium and alloys thereof, silver coated copper, and silver coated aluminum, but it is preferred that the solder material comprise indium or indium-based compounds.

The solder-based interface materials, as described herein, have several advantages directly related to use and component engineering, such as: a) the interface material/polymer solder material can be used to fill gaps on the order of about 2 millimeters or smaller and very small gaps on the order of about 2 mils or smaller, b) the interface material/polymer solder material can efficiently transfer heat in those very small gaps as well as larger gaps, unlike most conventional solder materials, and c) the interface material/polymer solder material can be easily incorporated into micro components, components used for satellites, and small electronic components.

Resin-containing interface materials and solder materials, especially those comprising silicone resins, that may also have appropriate thermal fillers can exhibit a thermal capability of less than about 0.5 cm²° C./w. Unlike thermal grease, thermal performance of the material will not degrade after thermal cycling or flow cycling in IC devices because liquid silicone resins will cross link to form a soft gel upon heat activation.

Interface materials and polymer solders comprising resins, such as silicone resins, will not be “squeezed out” as thermal grease can be in use and will not display interfacial delamination during thermal cycling. The new material can be provided as a dispensable liquid paste to be applied by dispensing methods and then cured as desired. It can also be provided as a highly compliant, cured, and possibly cross-linkable elastomer film or sheet for pre-application on interface surfaces, such as heat sinks. Advantageously, fillers with a thermal conductivity of greater than about 2 and preferably at least about 4 w/m° C. will be used. Optimally, it is desired to have a filler of not less than about 10 w/m° C. thermal conductivity. The interface material enhances thermal dissipation of high power semiconductor devices. The paste may be formulated as a mixture of functional silicone resins and thermal fillers.

A vinyl Q resin is an activated cure specialty silicone rubber having the following base polymer structure:

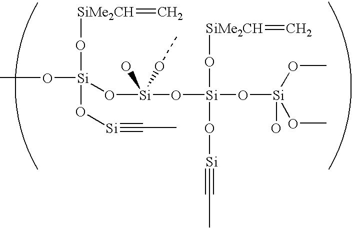

Vinyl Q resins are also clear reinforcing additives for addition cure elastomers. Examples of vinyl Q resin dispersions that have at least about 20% Q-resin are VQM-135 (DMS-V41 Base), VQM-146 (DMS-V46 Base), and VQX-221 (50% in xylene Base).

As an example, a contemplated silicone resin mixture could be formed as follows:

| Component | % by weight | Note/Function |
|---|---|---|
| Vinyl silicone | 75 (70-97 range) | Vinyl terminated siloxane |
| Vinyl Q Resin | 20 (0-25 range) | Reinforcing additive |
| Hydride functional | 15 (3-10 range) | Crosslinker |
| siloxane | | |
| Platinum-vinylsiloxane | 20-200 ppm | Catalyst |

The resin mixture can be cured at either at room temperature or at elevated temperatures to form a compliant elastomer. The reaction is via hydrosilylation (addition cure) of vinyl functional siloxanes by hydride functional siloxanes in the presence of a catalyst, such as platinum complexes or nickel complexes. Preferred platinum catalysts are SIP6830.0, SIP6832.0, and platinum-vinylsiloxane.

Contemplated examples of vinyl silicone include vinyl terminated polydimethyl siloxanes that have a molecular weight of about 10000 to 50000. Contemplated examples of hydride functional siloxane include methylhydrosiloxane-dimethylsiloxane copolymers that have a molecular weight about 500 to 5000. Physical properties can be varied from a very soft gel material at a very low crosslink density to a tough elastomer network of higher crosslink density.

Solder materials, as previously disclosed, that are dispersed in the resin mixture are contemplated to be any suitable solder material for the desired application. Several contemplated solder materials are indium tin (InSn) complexes, indium silver (InAg) complexes and alloys, indium-based compounds, tin silver copper complexes (SnAgCu), tin bismuth complexes and alloys (SnBi), and aluminum-based compounds and alloys. Of these, especially contemplated solder materials are those materials that comprise indium.

As with the previously described thermal interface materials and components, thermal filler particles may be dispersed in the resin mixture. If thermal filler particles are present in the resin mixture, then those filler particles should advantageously have a high thermal conductivity. Suitable filler materials include silver, copper, aluminum, and alloys thereof; boron nitride, aluminum spheres, aluminum nitride, silver coated copper, silver coated aluminum, carbon fibers, and carbon fibers coated with metals, metal alloys, conductive polymers or other composite materials. Combinations of boron nitride and silver or boron nitride and silver/copper also provide enhanced thermal conductivity. Boron nitride in amounts of at least about 20 wt. %, aluminum spheres in amounts of at least about 70 wt. %, and silver in amounts of at least about 60 wt. % are particularly useful.

Of special efficacy is a filler comprising a particular form of carbon fiber referred to as “vapor grown carbon fiber” (VGCF) such as is available from Applied Sciences, Inc., Cedarville, Ohio. VGCF, or “carbon micro fibers”, are a highly graphized type by heat treatment (thermal conductivity=about 1900 w/m° C.). Addition of about 0.5 wt. % carbon micro fibers provides significantly increased thermal conductivity. Such fibers are available in varying lengths and diameters; namely, about 1 mm to tens of centimeters in length and from under about 0.1 to over about 100 μm in diameter. One useful form has a diameter of not greater than about 1 μm and a length of about 50 to 100 μm, and possesses a thermal conductivity of about two or three times greater than with other common carbon fibers having diameters greater than about 5 μm.

It may also be advantageous to incorporate substantially spherical filler particles to maximize packing density. Additionally, substantially spherical shapes or the like will also provide some control of the thickness during compaction. Dispersion of filler particles can be facilitated by the addition of functional organometallic coupling agents or wetting agents, such as organosilane, organotitanate, organozirconium, etc. The organometallic coupling agents, especially organotitanate, may also be used to facilitate melting of the solder material during the application process. Typical particle sizes useful for fillers in the resin material may be in the range of about 1-20 μm with a maximum of about 100 μm.

To illustrate the invention, a number of examples were prepared by mixing the components described in Examples A through J below. The examples shown include one or more of the optional additions, e.g., wetability enhancer. The amounts of such additions may vary but, generally, they may be usefully present in the following approximate amounts (in 5 wt. %): filler up to about 95% of total (filler plus resins); wetability enhancer about 0.1 to 5% (of total); and adhesion promoters about 0.01 to 1% (of total). It should be noted the addition at least about 0.5% carbon fiber significantly increases thermal conductivity. The examples also show various physico-chemical measurements for the contemplated mixtures.

| Example | A | B | C | D | E | F | G | H | I | J |
|---|---|---|---|---|---|---|---|---|---|---|
| Silicone Mixture | 16 | 5 | 8 | 5 | 5 | 5 | 5 | 5 | 4 | 4 |
| Organotitanate | 4 | 3 | 0 | 3 | 3 | 3 | 3 | 3 | 3 | 3 |
| InSn | | 92 | 92 | 82 | | | | | | |
| InAg | | | | | 63 | | | | | |
| In | | | | | | 63 | | | | |
| SnAgCu | | | | | | | 92 | 82 | | |
| SnBi | | | | | | | | | 83 | 68 |
| Al | 80 | | | 10 | 29 | 29 | | 10 | 10 | 25 |
| Modulus (MPa) | 25 | 15 | 25 | 15 | 20 | 23 | 25 | 30 | 20 | 25 |
| Viscosity (poises) | 1400 | 500 | 1200 | 450 | 1500 | 1600 | 500 | 750 | 650 | 1700 |
| Thermal | 0.3 | 0.15 | 0.4 | 0.14 | 0.14 | 0.12 | 0.16 | 0.17 | 0.18 | 0.10 |
| Impedence | | | | | | | | | | |
| (cm² ° C./w) | | | | | | | | | | |
| Thermal | 2.5 | 5.1 | 2.0 | 5.5 | 5.8 | 6.2 | 5.2 | 5.0 | 5.0 | 6.0 |
| Conductivity | | | | | | | | | | |
| (W/m ° C.) | | | | | | | | | | |

Components organotitanate, InSn, InAg, In, SnAgCu, SnBi, and Al are presented as weight percent or as wt. %.

Example A contains no solder material and is provided for reference purposes. Organotitanate is functioning not only as a wetting enhancer, but also as a fluxing agent to facilitate melting of the solder material during the application process.

The solder compositions for these examples are as follows: InSn=about 52% In (by weight) and about 48% Sn (by weight) with a melting point of about 118° C.; InAg=about 97% In (by weight) and about 3% Ag (by weight) with a melting point of about 143° C.; In=about 100% Indium (by weight) with a melting point of 157° C.; SnAgCu=about 94.5% Tin (by weight), about 3.5% Silver (by weight) and about 2% Copper (by weight) with a melting point of about 217° C.; SnBi=about 60% Tin (by weight) and about 40% Bismuth (by weight) with a melting point of about 170° C. It should be appreciated that other compositions comprising different component percentages can be derived from the subject matter contained herein.

The processing temperatures are as follows: Examples A-E=about 150° C. for about 30 minutes; Examples F, J and I=about 200° C. for about 30 seconds and about 150° C. for about 30 minutes; Examples G and H=about 240° C. for about 30 seconds and about 150° C. for about 30 minutes.

Heat spreader components or heat spreading components (heat spreader and heat spreading are used herein interchangeably and have the same common meaning) generally comprise at least one metal or metal-based base material, such as nickel, aluminum, copper, or AlSiC. Any suitable metal or metal-based base material can be used herein as a heat spreader, as long as the metal or metal-based base material can transfer some or all of the heat generated by the electronic component. Specific examples of contemplated heat spreader components are shown under the Examples section.

Heat spreader components can be manufactured, such as rolled or stamped, in any suitable thickness, depending on the needs of the electronic component, the vendor and as long as the heat spreader component is able to sufficiently perform the task of dissipating some or all of the heat generated from the surrounding electronic component. Contemplated thicknesses comprise thicknesses in the range of about 0.25 mm to about 6 mm. Especially preferred thicknesses of heat spreader components are within the range of about 1 mm to about 5 mm.

A method of forming contemplated layered thermal components comprises: a) providing at least one thermal interface component; b) providing at least one heat spreader component; and c) physically coupling the thermal interface component and the heat spreader component.

The thermal interface components and the heat spreader components can be individually prepared and provided by using the methods previously described herein. The two components are then physically coupled to produce a layered interface material. As used herein, the term “interface” means a couple or bond that forms the common boundary between two parts of matter or space. An interface may comprise a physical attachment or physical couple of two parts of matter or components or a physical attraction between two parts of matter or components, including bond forces such as covalent and ionic bonding, and non-bond forces such as Van der Waals, electrostatic, coulombic, hydrogen bonding and/or magnetic attraction. The two components, as described herein, may also be physically coupled by the act of applying one component to the surface of the other component.

The layered thermal component may then be applied to a substrate, another surface, or another layered component. A contemplated electronic component comprises a layered thermal component, a substrate layer and at least one additional layer. The layered thermal component comprises a heat spreader component and a thermal interface component. Substrates contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polymimide. The “substrate” may even be defined as another polymer material when considering cohesive interfaces. In more preferred embodiments, the substrate comprises a material common in the packaging and circuit board industries such as silicon, copper, glass, and another polymer.

Additional layers of material may be coupled to the layered interface materials in order to continue building a layered component or printed circuit board. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

A layer of laminating material or cladding material can be coupled to the layered interface materials depending on the specifications required by the component. Laminates are generally considered fiber-reinforced resin dielectric materials. Cladding materials are a subset of laminates that are produced when metals and other materials, such as copper, are incorporated into the laminates. (Harper, Charles A., Electronic Packaging and Interconnection Handbook, Second Edition, McGraw-Hill (New York), 1997.)

Spin-on layers and materials may also be added to the layered interface materials or subsequent layers. Spin-on stacked films are taught by Michael E. Thomas, “Spin-On Stacked Films for Low keff Dielectrics”, Solid State Technology (July 2001), incorporated herein in its entirety by reference.

Applications of the contemplated thermal interface components, layered interface materials and heat spreader components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

### EXAMPLES

The following examples show a basic procedure and testing mechanism for pre-assembling several of the layered materials disclosed herein. The testing parameters and discussion uses nickel as a heat spreader component. However, it should be understood that any suitable heat spreader component can be used for this application and layered material. Also, PCM45 is used herein in the examples as a representative phase change material component, however, it should be understood that any suitable phase change material component can be used according to the subject matter disclosed herein.

### Example 1

BASIC PROCEDURE FOR ASSEMBLY

Equipment

Heat tunnel, refrigerator.

Proper fixturing for locating the component and pressing of the PCM materials.

Supplies

Latex, non powdered gloves. Do not use (blue) nitrile gloves since they will stain Ni plated surfaces.

Wipes

Isopropyl alcohol

Material

Heat spreader component

Pre-cut PCM material or suitable phase change material per specifications of the vendor and/or manufacturer.

Fixturing (specific fixturing, preferably nylon, for the component and PCM material)

Safety and Environment

Safety glasses

When operating any type of conveyor, always make sure hands are clear of any pinch

Instructions

Pull a 32 piece random sample of the component for outgoing inspection prior to applying PCM material.

Use only a phase change material that has passed the inspection criteria similar to those discussed herein; Start with room temp. phase change material, such as PCM 45. If the both top and bottom release liners fall off prematurely, warm the PCM material for >about 0.5 hr at about 30° C.

Ensure that the substrate temperature is greater than about 21° C.

Apply the phase change material to component per the following instructions:
The release liner is (short one preferably) removed to expose the phase change material to apply the material to the component.
Locate the alignment jig on the component, apply the phase change material with light finger pressure.
Run through heat tunnel to bring the combination part to an exit temperature of between about 48 and about 60° C. Residence time can be from about 30 to about 60 seconds.
Apply light finger pressure to PCM45 to ensure complete attachment
Refrigerate to less than about −10° C. for greater than about ten minutes
Remove top liner
Visually inspect combination part for defects
Load into trays
   Quality Requirements

Sampling Plan.
Inspect each component after application for location and visual requirements.

Inspection Instructions.
At 1×, 12″-14″ from the eye, visually inspect the PCM material to insure location and visual criteria.

Accept/Reject Criteria.
Visually inspect for any deformation around the edges of the material. Also re-inspect the substrate for staining and or scratches as per the relevant quality workmanship standards for the component.
Note: If this failure occurs, the parts need to be left the refrigerator longer

Rework of phase change material component application
Phase change material component failing visual inspection can be reworked immediately.
Using a plastic scraper, remove the rejected phase change material from the component.
Use isopropyl alcohol and a wipe to remove any adhesive.
Return to second step under Instructions where phase change material component is provided.

### Example 2

BASIC PROCEDURE FOR ASSEMBLY

Equipment

Heat tunnel, refrigerator.

Proper fixturing for locating the component and pressing of the PCM materials.

Supplies

Latex, non powdered gloves. Do not use (blue) nitrile gloves since they will stain Ni plated surfaces.

Wipes

Isopropyl alcohol

Material

Heat spreader component

Pre-cut polymer solder material per specifications of the vendor and/or manufacturer.

Fixturing (specific fixturing, preferably nylon, for the component and polymer solder material)

Safety and Environment

Safety glasses

When operating any type of conveyor, always make sure hands are clear of any pinch

Instructions

Pull a 32 piece random sample of the component for outgoing inspection prior to applying polymer solder material.

Use only a polymer solder material that has passed the inspection criteria similar to those discussed herein; Start with room temp. polymer solder material. If the both top and bottom release liners fall off prematurely, warm the polymer solder material for >about 0.5 hr at about 30° C.

Ensure that the substrate temperature is greater than about 21° C.

Apply the polymer solder material to component per the following instructions:
The release liner is (short one preferably) removed to expose the polymer solder material to apply the material to the component.
Locate the alignment jig on the component, apply the polymer solder material with light finger pressure.
Run through heat tunnel to bring the combination part to an exit temperature of between about 48 and about 60° C. Residence time can be from about 30 to about 60 seconds.
Apply light finger pressure to polymer solder material to ensure complete attachment
Refrigerate to less than about −10° C. for greater than ten minutes
Remove top liner
Visually inspect combination part for defects
Load into trays
   Quality Requirements

Sampling Plan.
Inspect each component after application for location and visual requirements.

Inspection Instructions.
At 1×, 12″-14″ from the eye, visually inspect the polymer solder material to insure location and visual criteria.

Accept/Reject Criteria.
Visually inspect for any deformation around the edges of the material. Also re-inspect the substrate for staining and or scratches as per the relevant quality workmanship standards for the component.
Note: If this failure occurs, the parts need to be left the refrigerator longer

Rework of polymer solder material component application
Polymer solder material component failing visual inspection can be reworked immediately.
Using a plastic scraper, remove the rejected polymer solder material from the component.
Use isopropyl alcohol and a wipe to remove any adhesive.
Return to second step under Instructions where polymer solder material component is provided.

### Example 3

BASIC PROCEDURE FOR ASSEMBLY

Equipment

Heat tunnel, refrigerator.

Proper fixturing for locating the component and pressing of the solder/solder paste materials.

Supplies

Latex, non powdered gloves. Do not use (blue) nitrile gloves since they will stain Ni plated surfaces.

Wipes

Isopropyl alcohol

Material

Heat spreader component

Preform solder or solder paste material per specifications of the vendor and/or manufacturer.

Fixturing (specific fixturing, preferably nylon, for the component and solder/solder paste material)

Safety and Environment

Safety glasses

When operating any type of conveyor, always malke sure hands are clear of any pinch

Instructions

Pull a 32 piece random sample of the component for outgoing inspection prior to applying solder/solder paste material.

Ensure that the substrate temperature is greater than about 21° C.

Apply the solder/solder paste material to component per the following instructions:
Locate the alignment jig on the component, apply the phase change material with light finger pressure.
Place a weight or a clamp on top of the solder/solder paste materials.
Run through heat tunnel (in nitrogen atmosphere) to bring the combination part to an exit temperature of between about 170 and about 200° C. Residence time can be from about 2 to about 5 minutes.
Visually inspect combination part for defects
Load into trays

Flux may or may not be used in the solder/solder paste applications. If flux is used, a cleaning step should be added afterwards in order to clean the flux off of the component.

Quality Requirements

Sampling Plan.
Inspect each component after application for location and visual requirements.

Inspection Instructions.
At 1×, 12″-14″ from the eye, visually inspect the solder/solder paste material to insure location and visual criteria.

Accept/Reject Criteria.
Visually inspect for any deformation around the edges of the material. Also re-inspect the substrate for staining and or scratches as per the relevant quality workmanship standards for the component.

As discussed herein, the thermal interconnect system, thermal interface and interface materials are beneficial for many reasons. One reason is that the heat spreader component and interface material has excellent wetting at the interface between the heat spreader component and the interface material, and this interfacial wetting is able to withstand the most extreme conditions. A second reason is that the heat spreader component/thermal interface material combination disclosed and discussed herein reduces the number of steps necessary for package assembly by the customer—given that its pre-assembled and quality checked before the customer receives it. The pre-assembly of the component also reduces the associated costs on the part of the customer. A third reason is that the heat spreader component and the thermal interface material can be designed to “work together”, so that the interfacial thermal resistance is minimized for the specific combination of heat spreader component and thermal interface material.

Thus, specific embodiments and applications of thermal interconnect and interface materials have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A layered thermal component, comprising:
at least one thermal interface component, wherein the thermal interface component comprises at least one rubber compound having at least one terminal hydroxyl group and at least one thermally conductive filler material; and
at least one heat spreader component coupled to the thermal interface component.

2. The layered thermal component of claim 1, wherein the at least one thermal interface component comprises a crosslinkable material.

3. (canceled)

4. The layered thermal component of claim 2, wherein the at least one thermal interface component further comprises at least one crosslinker moiety, at least one crosslinking compound or at least one crosslinking resin.

5. The layered thermal component of claim 4, wherein the at least one crosslinker moiety, the at least one crosslinking compound or the at least one crosslinking resin comprises an amine resin or an amine-based compound.

6. (canceled)

7. The layered thermal component of one of claims 1 or 6, wherein the at least one rubber compound comprises at least one secondary, tertiary or otherwise internal hydroxyl group.

8. The layered thermal component of claim 1, wherein the at least one thermal interface component comprises at least one solder material.

9. The layered thermal component of claim 8, wherein the at least one solder material comprises a paste.

10. The layered thermal component of claim 8, wherein the at least one solder material comprises at least one of the following: indium, copper, silver, aluminum, gallium, tin or bismuth.

11. The layered thermal component of claim 8, wherein the at least one thermal interface component further comprises at least one resin component.

12. The layered thermal component of claim 11, wherein the at least one resin component comprises a silicone compound.

13. The layered thermal component of claim 12, wherein the silicone compound comprises a vinyl Q resin or a vinyl silicone.

14. The layered thermal component of claim 11, wherein the at least one solder material comprises at least one of the following: indium, tin, silver, bismuth or aluminum.

15. The layered thermal component of claim 11, further comprising a crosslinking additive.

16. The layered thermal component of claim 15, where in the crosslinking additive comprises a siloxane compound.

17. The layered thermal component of claim 16, wherein the siloxane compound comprises a hydride functional siloxane compound.

18. The layered thermal component of claim 1, wherein the at least one heat spreader component comprises at least one metal or metal-based base material.

19. The layered thermal component of claim 18, wherein the at least one metal or metal-based base material comprises nickel, aluminum or copper.

20. The layered thermal component of claim 19, wherein the at least one metal or metal-based base material comprises AlSiC.

21. The layered thermal component of claim 1, wherein the at least one heat spreader component has a thickness of about 0.25 mm to about 6 mm.

22. The layered thermal component of claim 21, wherein the at least one heat spreader component has a thickness of about 1 mm to about 5 mm.

23. A method of forming a layered thermal component, comprising:
providing at least one thermal interface component, wherein the thermal interface component comprises at least one rubber compound having at least one terminal hydroxyl group and at least one thermally conductive filler material;
providing at least one heat spreader component; and
coupling the at least one thermal interface component to the at least one heat spreader component.

24. The method of claim 23, wherein the at least one thermal interface component comprises a crosslinkable material.

25. (canceled)

26. The method of claim 24, wherein the at least one thermal interface component further comprises at least one crosslinker moiety, at least one crosslinking compound or at least one crosslinking resin.

27. The method of claim 26, wherein the at least one crosslinker moiety, the at least one crosslinking compound or the at least one crosslinking resin comprises an amine resin or an amine-based compound.

28. canceled

29. The method of one of claims 23 or 28, wherein the at least one rubber compound comprises at least one secondary, tertiary or otherwise internal hydroxyl group.

30. The method of claim 23, wherein the at least one thermal interface component comprises at least one solder material.

31. The method of claim 30, wherein the at least one solder material comprises a paste.

32. The method of claim 30, wherein the at least one solder material comprises at least one of the following: indium, copper, silver, aluminum, gallium, tin or bismuth.

33. The method of claim 30, wherein the at least one thermal interface component further comprises at least one resin component.

34. The method of claim 33, wherein the at least one resin component comprises a silicone compound.

35. The method of claim 34, wherein the silicone compound comprises a vinyl Q resin or a vinyl silicone.

36. The method of claim 33, wherein the at least one solder material comprises at least one of the following: indium, tin, silver, bismuth or aluminum.

37. The method of claim 33, further comprising a crosslinking additive.

38. The method of claim 37, wherein the crosslinking additive comprises a siloxane compound.

39. The method of claim 38, wherein the siloxane compound comprises a hydride functional siloxane compound.

40. The method of claim 23, wherein the at least one heat spreader component comprises at least one metal or metal-based base material.

41. The method of claim 40, wherein the at least one metal or metal-based base material comprises nickel, aluminum or copper.

42. The method of claim 41, wherein the at least one metal or metal-based base material comprises AlSiC.

43. The method of claim 23, wherein the at least one heat spreader component has a thickness of about 0.25 mm to about 6 mm.

44. The method of claim 43, wherein the at least one heat spreader component has a thickness of about 1 mm to about 5 mm.

45. An electronic component comprising the layered thermal component of claim 1.

46. A semiconductor component comprising the layered thermal component of claim 1.

47. An electronic component comprising the layered thermal component of claim 23.

48. A semiconductor component comprising the layered thermal component of claim 23.

49. A method for forming the thermal interface component of claim 1 or claim 23, comprising:
providing at least one saturated rubber compound;
providing at least one amine resin;
crosslinking the at least one saturated rubber compound and the at least one amine resin to form a crosslinked rubber-resin mixture;
adding at least one thermally conductive filler to the crosslinked rubber-resin mixture; and
adding a wetting agent to the crosslinked rubber-resin mixture.

50. The method of claim 49, further comprising adding at least one phase change material to the thermal interface material.
